(19) United States
(12) Patent Application Publication
(10) Pub. No.: US 2026/0177783 A1
(43) Pub. Date: Jun. 25, 2026

(54) OPTICAL IMAGING LENS

(71) Applicant: Genius Electronic Optical (Xiamen) Co., Ltd., Xiamen (CN)

(72) Inventors: Qingzhi Zhu, Xiamen (CN); QIDA ZHAO, Xiamen (CN); Meiting He, Xiamen (CN); Hung-Chien Hsieh, Taichung City (TW)

(73) Assignee: Genius Electronic Optical (Xiamen) Co., Ltd., Xiamen (CN)

(21) Appl. No.: 19/054,915

(22) Filed: Feb. 17, 2025

(30) Foreign Application Priority Data
Dec. 24, 2024 (CN) 202411918281.9

(51) Int. Cl. G02B 13/00; G02B 9/62

(52) U.S. Cl. CPC G02B 13/0045; G02B 9/62

(57) ABSTRACT

An optical imaging lens includes a first lens element to a sixth lens element. A periphery region of the image-side surface of a first lens element is convex, a periphery region of the image-side surface of the second lens element is concave, an optical axis region of the object-side surface of the fourth lens element is convex, a periphery region of the object-side surface of the fourth lens element is concave, a periphery region of the image-side surface of the fourth lens element is concave, and an optical axis region of the object-side surface of the fifth lens element is concave. Lens elements included by the optical imaging lens are only six lens elements described above to satisfy (T5+BFL)/(T1+G12)≥4.390.

### BACKGROUND OF THE INVENTION

### 1. Field of the Invention

The present invention generally relates to an optical imaging lens. Specifically speaking, the present invention is directed to an optical imaging lens for using in portable electronic devices, such as a mobile phone, a camera, a tablet personal computer, a personal digital assistant (PDA) or a head-mounted display device (AR, VR, MR) and for taking pictures or for recording videos.

### 2. Description of the Prior Art

In recent years, an optical imaging lens has been evolving and applied in a wider range. In addition to the requirements of being lighter, thinner, shorter and smaller, the design of a smaller f-number (Fno) is conducive for the increase of the luminous flux and a larger field of view has become a gradual trend in recent years. Therefore, it is a challenging problem to be solved to design an optical imaging lens which is light, thin, short and small to have a small f-number and good imaging quality.

### SUMMARY OF THE INVENTION

Accordingly, various embodiments of the present invention propose an optical imaging lens of six lens elements with a smaller f-number (Fno), with a small size, of good imaging quality and which is technically possible. The optical imaging lens of six lens elements of the present invention from an object side to an image side in order along an optical axis has a first lens element, a second lens element, a third lens element, a fourth lens element, a fifth lens element and a sixth lens element. Each first lens element, second lens element, third lens element, fourth lens element, fifth lens element and sixth lens element has an object-side surface which faces toward the object side and allows imaging rays to pass through as well as an image-side surface which faces toward the image side and allows the imaging rays to pass through.

In one embodiment, a periphery region of the image-side surface of a first lens element is convex, a periphery region of the image-side surface of the second lens element is concave, an optical axis region of the object-side surface of the fourth lens element is convex, a periphery region of the object-side surface of the fourth lens element is concave and a periphery region of the image-side surface of the fourth lens element is concave, and an optical axis region of the object-side surface of the fifth lens element is concave. Lens elements included by the optical imaging lens are only the six lens elements described above to satisfy the relationship: (T5+BFL)/(T1+G12)≥4.390.

In another embodiment, a periphery region of the image-side surface of a first lens element is convex, a periphery region of the object-side surface of the second lens element is convex and a periphery region of the image-side surface of the second lens element is concave, an optical axis region of the object-side surface of the fourth lens element is convex and a periphery region of the image-side surface of the fourth lens element is concave, and an optical axis region of the object-side surface of the sixth lens element is convex and an optical axis region of the image-side surface of the sixth lens element is concave. Lens elements included by the optical imaging lens are only the six lens elements described above to satisfy the relationship: (T5+BFL)/(T1+G12)≥4.390.

In another embodiment, a periphery region of the image-side surface of a first lens element is convex, a periphery region of the image-side surface of the second lens element is concave, a periphery region of the image-side surface of a third lens element is convex, a periphery region of the object-side surface of the fourth lens element is concave and a periphery region of the image-side surface of the fourth lens element is concave, an optical axis region of the object-side surface of the fifth lens element is concave, and an optical axis region of the image-side surface of the sixth lens element is concave. Lens elements included by the optical imaging lens are only the six lens elements described above to satisfy the relationship: (T5+BFL)/(T1+G12)≥4.390.

In the optical imaging lens of the present invention, the embodiments may also selectively satisfy the following conditions:

$$( T 3 + T 5 ) / T 1 \geq 2.4 ;$$

$$( G 23 + T 3 + T 5 ) / AAG \geq 1 \text{.500} ;$$

$$( T 5 + T 6 ) / Tavg \geq 2 \text{.600} ;$$

$${EFL}^{⋆} Fno / Tavg \leq 14 \text{.000} ;$$

$$T 3 / ( G 34 + G 56 ) \geq 3. ;$$

$$TTL / ( G 12 + G 23 + G 34 + G 56 ) \geq 12.4 ;$$

$$ALT / ( T 3 + T 5 + T 6 ) \leq 1 \text{.650} ;$$

$$EFL / BFL \leq 2 \text{.500} ;$$

$$ALT / AAG \geq 2 \text{.900} ;$$

$$ImgH / ( T 2 + G 23 + T 4 + G 45 + T 6 ) \geq 1.5 ;$$

$$BFL / ( G 12 + G 34 + G 56 ) \geq 9.2 ;$$

$$( EFL + TL ) / ( T 2 + G 23 + T 4 + G 45 + T 6 + BFL ) \leq 2 \text{.300} ;$$

$$( T max + BFL ) / ( T min + AAG ) \geq 1 \text{.600} ;$$

$$EFL / ( BFL + T 5 ) \leq 1 \text{.600} ;$$

$$BFL / ( G 12 + G 23 + G 34 ) \geq 3 \text{.200} ;$$

$$( T 3 + G 34 + T 4 + G 45 + T 5 ) / ( T 1 + G 12 + T 2 ) \geq 2 \text{.100} ;$$

$$( T 5 + T 6 + BFL ) / ( T 1 + G 12 + T 2 + G 23 ) \geq 2 \text{.700} ;$$

$$ALT / ( G 23 + T 3 + BFL ) \leq 1 \text{.500} ;$$

$$AAG / T 5 \leq 1.7 ,$$

wherein: T1 is a thickness of the first lens element along the optical axis; T2 is a thickness of the second lens element along the optical axis; T3 is a thickness of the third lens element along the optical axis; T4 is a thickness of the fourth lens element along the optical axis; T5 is a thickness of the fifth lens element along the optical axis; and T6 is a thickness of the sixth lens element along the optical axis. Tmax is a maximal lens element thickness among the first lens element and the sixth lens element along the optical axis, i.e. a maximal value among T1, T2, T3, T4, T5, T6. Tmin is a minimal lens element thickness among the first lens element and the sixth lens element along the optical axis, i.e. a minimal value among T1, T2, T3, T4, T5, T6. Tavg is an average value of the thickness of the six lens elements from the first lens element to the sixth lens element along the optical axis, i.e. an average value of T1, T2, T3, T4, T5, T6.

G12 is a distance of an air gap between the first lens element and the second lens element along the optical axis; G23 is a distance of an air gap between the second lens element and the third lens element along the optical axis; G34 is a distance of an air gap between the third lens element and the fourth lens element along the optical axis; G45 is a distance of an air gap between the fourth lens element and the fifth lens element along the optical axis; G56 is a distance of an air gap between the fifth lens element and the sixth lens element along the optical axis.

Fno is an f-number of the optical imaging lens, and AAG is a sum of a distance of the five air gaps from the first lens element to the sixth lens element along the optical axis. ImgH is an image height of the optical imaging lens. TL is a distance from the object-side surface of the first lens element to the image-side surface of the sixth lens element along the optical axis. ALT is a sum of thicknesses of all the six lens elements from the first lens element to the sixth lens element along the optical axis. TTL is a distance from the object-side surface of the first lens element to an image plane along the optical axis. BFL is a distance from the image-side surface of the sixth lens element to the image plane along the optical axis. HFOV is a half of the field of view. EFL is an effective focal length of the optical imaging lens.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-5 illustrate the methods for determining the surface shapes and for determining an optical axis region and a periphery region of one lens element.

FIG. 6 illustrates a first embodiment of the optical imaging lens of the present invention.

FIG. 7A illustrates the longitudinal spherical aberration on the image plane of the first embodiment.

FIG. 7B illustrates the field curvature aberration on the sagittal direction of the first embodiment.

FIG. 7C illustrates the field curvature aberration on the tangential direction of the first embodiment.

FIG. 7D illustrates the distortion aberration of the first embodiment.

FIG. 8 illustrates a second embodiment of the optical imaging lens of the present invention.

FIG. 9A illustrates the longitudinal spherical aberration on the image plane of the second embodiment.

FIG. 9B illustrates the field curvature aberration on the sagittal direction of the second embodiment.

FIG. 9C illustrates the field curvature aberration on the tangential direction of the second embodiment.

FIG. 9D illustrates the distortion aberration of the second embodiment.

FIG. 10 illustrates a third embodiment of the optical imaging lens of the present invention.

FIG. 11A illustrates the longitudinal spherical aberration on the image plane of the third embodiment.

FIG. 11B illustrates the field curvature aberration on the sagittal direction of the third embodiment.

FIG. 11C illustrates the field curvature aberration on the tangential direction of the third embodiment.

FIG. 11D illustrates the distortion aberration of the third embodiment.

FIG. 12 illustrates a fourth embodiment of the optical imaging lens of the present invention.

FIG. 13A illustrates the longitudinal spherical aberration on the image plane of the fourth embodiment.

FIG. 13B illustrates the field curvature aberration on the sagittal direction of the fourth embodiment.

FIG. 13C illustrates the field curvature aberration on the tangential direction of the fourth embodiment.

FIG. 13D illustrates the distortion aberration of the fourth embodiment.

FIG. 14 illustrates a fifth embodiment of the optical imaging lens of the present invention.

FIG. 15A illustrates the longitudinal spherical aberration on the image plane of the fifth embodiment.

FIG. 15B illustrates the field curvature aberration on the sagittal direction of the fifth embodiment.

FIG. 15C illustrates the field curvature aberration on the tangential direction of the fifth embodiment.

FIG. 15D illustrates the distortion aberration of the fifth embodiment.

FIG. 16 illustrates a sixth embodiment of the optical imaging lens of the present invention.

FIG. 17A illustrates the longitudinal spherical aberration on the image plane of the sixth embodiment.

FIG. 17B illustrates the field curvature aberration on the sagittal direction of the sixth embodiment.

FIG. 17C illustrates the field curvature aberration on the tangential direction of the sixth embodiment.

FIG. 17D illustrates the distortion aberration of the sixth embodiment.

FIG. 18 illustrates a seventh embodiment of the optical imaging lens of the present invention.

FIG. 19A illustrates the longitudinal spherical aberration on the image plane of the seventh embodiment.

FIG. 19B illustrates the field curvature aberration on the sagittal direction of the seventh embodiment.

FIG. 19C illustrates the field curvature aberration on the tangential direction of the seventh embodiment.

FIG. 19D illustrates the distortion aberration of the seventh embodiment.

FIG. 20 illustrates an eighth embodiment of the optical imaging lens of the present invention.

FIG. 21A illustrates the longitudinal spherical aberration on the image plane of the eighth embodiment.

FIG. 21B illustrates the field curvature aberration on the sagittal direction of the eighth embodiment.

FIG. 21C illustrates the field curvature aberration on the tangential direction of the eighth embodiment.

FIG. 21D illustrates the distortion aberration of the eighth embodiment.

FIG. 22 shows the optical data of the first embodiment of the optical imaging lens.

FIG. 23 shows the aspheric surface data of the first embodiment.

FIG. 24 shows the optical data of the second embodiment of the optical imaging lens.

FIG. 25 shows the aspheric surface data of the second embodiment.

FIG. 26 shows the optical data of the third embodiment of the optical imaging lens.

FIG. 27 shows the aspheric surface data of the third embodiment.

FIG. 28 shows the optical data of the fourth embodiment of the optical imaging lens.

FIG. 29 shows the aspheric surface data of the fourth embodiment.

FIG. 30 shows the optical data of the fifth embodiment of the optical imaging lens.

FIG. 31 shows the aspheric surface data of the fifth embodiment.

FIG. 32 shows the optical data of the sixth embodiment of the optical imaging lens.

FIG. 33 shows the aspheric surface data of the sixth embodiment.

FIG. 34 shows the optical data of the seventh embodiment of the optical imaging lens.

FIG. 35 shows the aspheric surface data of the seventh embodiment.

FIG. 36 shows the optical data of the eighth embodiment of the optical imaging lens.

FIG. 37 shows the aspheric surface data of the eighth embodiment.

FIG. 38 shows some important ratios in the embodiments.

### DETAILED DESCRIPTION

The terms “optical axis region”, “periphery region”, “concave”, and “convex” used in this specification and claims should be interpreted based on the definition listed in the specification by the principle of lexicographer.

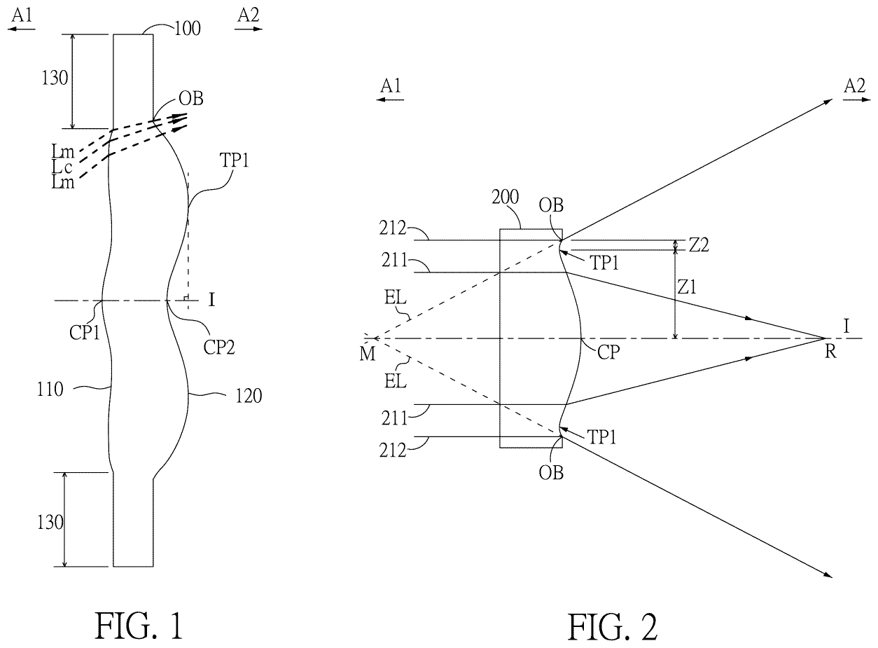

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex-(concave-) region,” can be used alternatively.

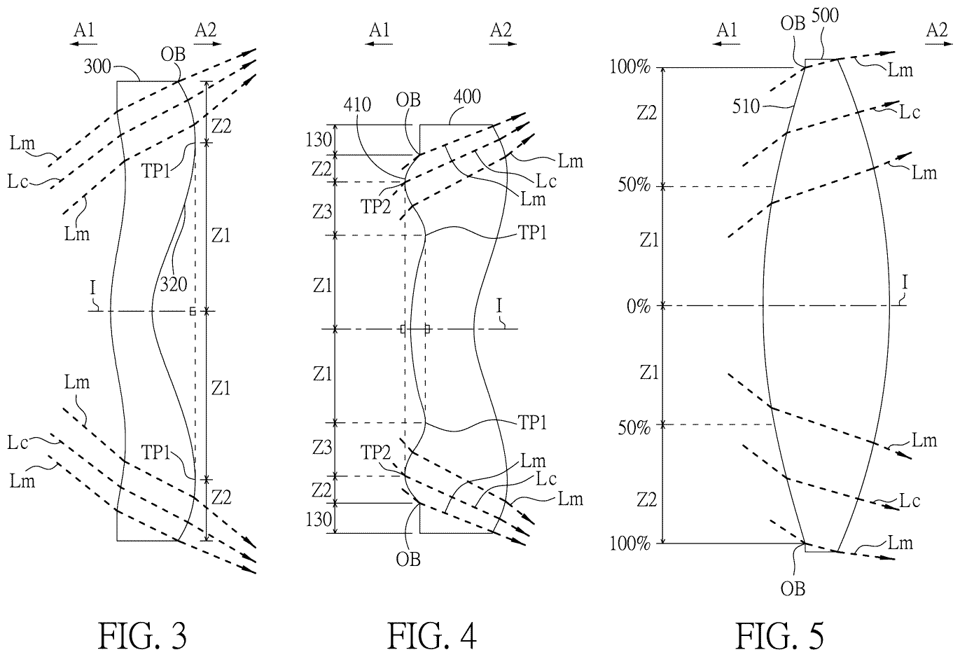

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region 22 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

As shown in FIG. 6, the optical imaging lens 1 of the present invention, located from an object side A1 (where an object is located) to an image side A2 along an optical axis I, is mainly composed of six lens elements, sequentially has an aperture stop 2, a first lens element 10, a second lens element 20, a third lens element 30, a fourth lens element 40, a fifth lens element 50, a sixth lens element 60 and an image plane 4. Generally speaking, the first lens element 10, the second lens element 20, the third lens element 30, the fourth lens element 40, the fifth lens element 50 and the sixth lens element 60 may be made of a transparent plastic material but the present invention is not limited to this. In the optical imaging lens 1 of the present invention, lens elements included by the optical imaging lens 1 are only the six lens elements (the first lens element 10, the second lens element 20, the third lens element 30, the fourth lens element 40, the fifth lens element 50 and the sixth lens element 60) described above. The optical axis I is the optical axis of the entire optical imaging lens 1, and the optical axis of each of the lens elements coincides with the optical axis I of the optical imaging lens 1.

Furthermore, the optical imaging lens 1 further includes an aperture stop (ape. stop) 2 disposed in an appropriate position. In FIG. 6, the aperture stop 2 is disposed at a side of the first lens element 10 which faces the object side A1, in other words disposed between the object side A1 and the first lens element 10. When imaging rays emitted or reflected by an object (not shown) which is located at the object side A1 enters the optical imaging lens 1 of the present invention, the imaging rays form a clear and sharp image on the image plane 4 at the image side A2 after passing through the aperture stop 2, the first lens element 10, the second lens element 20, the third lens element 30, the fourth lens element 40, the fifth lens element 50, the sixth lens element 60 and a filter 3. In the embodiments of the present invention, the filter 3 may be a filter of various suitable functions, placed between the sixth lens element 60 and the image plane 4 to filter out light of a specific wavelength, for some embodiments, the filter 3 may be an infrared cut-off filter to keep the infrared light in the imaging rays from reaching the image plane 4 to jeopardize the imaging quality.

Each lens element of the optical imaging lens 1 has an object-side surface facing toward the object side A1 and allowing imaging rays to pass through as well as an image-side surface facing toward the image side A2 and allowing the imaging rays to pass through. In addition, each lens element of the optical imaging lens 1 has an optical axis region and a periphery region. For example, the first lens element 10 has an object-side surface 11 and an image-side surface 12; the second lens element 20 has an object-side surface 21 and an image-side surface 22; the third lens element 30 has an object-side surface 31 and an image-side surface 32; the fourth lens element 40 has an object-side surface 41 and an image-side surface 42; the fifth lens element 50 has an object-side surface 51 and an image-side surface 52; the sixth lens element 60 has an object-side surface 61 and an image-side surface 62. Furthermore, each object-side surface and image-side surface of lens elements in the optical imaging lens of present invention has an optical axis region and a periphery region.

Each lens element in the optical imaging lens 1 of the present invention further has a thickness T along the optical axis I. For example, the first lens element 10 has a first lens element thickness T1, the second lens element 20 has a second lens element thickness T2, the third lens element 30 has a third lens element thickness T3, the fourth lens element 40 has a fourth lens element thickness T4, the fifth lens element 50 has a fifth lens element thickness T5, and the sixth lens element 60 has a sixth lens element thickness T6. Therefore, a sum of thicknesses of all the six lens elements from the first lens element 10 to the sixth lens element 60 in the optical imaging lens 1 along the optical axis I is ALT. In other words, ALT=T1+T2+T3+T4+T5+T6. Tavg is an average value of the thicknesses of the six lens elements T1, T2, T3, T4, T5 and T6 from the first lens element 10 to the sixth lens element 60 along the optical axis I. Tmax is a maximal lens element thickness among the first lens element 10 and the sixth lens element 60 along the optical axis I, i.e. a maximal value among T1, T2, T3, T4, T5 and T6. Tmin is a minimal lens element thickness among the first lens element 10 and the sixth lens element 60 along the optical axis I, i.e. a minimal value among T1, T2, T3, T4, T5 and T6.

In addition, between two adjacent lens elements in the optical imaging lens 1 of the present invention there may be an air gap distance along the optical axis I. For example, there is an air gap distance G12 between the first lens element 10 and the second lens element 20, an air gap distance G23 between the second lens element 20 and the third lens element 30, an air gap distance G34 between the third lens element 30 and the fourth lens element 40, an air gap distance G45 between the fourth lens element 40 and the fifth lens element 50 as well as an air gap distance G56 between the fifth lens element 50 and the sixth lens element 60. Therefore, a sum of a distance of the five air gaps from the first lens element 10 to the sixth lens element 60 along the optical axis I is AAG. In other words, AAG=G12+G23+G34+G45+G56. Gmax is a maximal air gap distance among the first lens element 10 and the sixth lens element 60 along the optical axis I, i.e. a maximal value among G12, G23, G34, G45 and G56.

In addition, a distance from the object-side surface 11 of the first lens element 10 to the image plane 4, namely a system length of the optical imaging lens 1 along the optical axis I is TTL. An effective focal length of the optical imaging lens is EFL. A distance from the object-side surface 11 of the first lens element 10 to the image-side surface 62 of the sixth lens element 60 along the optical axis I is TL. ImgH is an image height of the optical imaging lens 1. Fno is an f-number of the optical imaging lens 1. HFOV stands for the half field of view of the optical imaging lens 1, which is a half of the field of view.

When the filter 3 is placed between the sixth lens element 60 and the image plane 4, an air gap distance between the sixth lens element 60 and the filter 3 along the optical axis I is G6F; a thickness of the filter 3 along the optical axis I is TF; an air gap distance between the filter 3 and the image plane 4 along the optical axis I is GFP. BFL is the back focal length of the optical imaging lens 1, namely a distance from the image-side surface 62 of the sixth lens element 60 to the image plane 4 along the optical axis I. Therefore, BFL=G6F+TF+GFP.

Furthermore, a focal length of the first lens element 10 is f1; a focal length of the second lens element 20 is f2; a focal length of the third lens element 30 is f3; a focal length of the fourth lens element 40 is f4; a focal length of the fifth lens element 50 is f5; a focal length of the sixth lens element 60 is f6. A refractive index (nd) of the first lens element 10 is n1; a refractive index (nd) of the second lens element 20 is n2; a refractive index (nd) of the third lens element 30 is n3; a refractive index (nd) of the fourth lens element 40 is n4; a refractive index (nd) of the fifth lens element 50 is n5; a refractive index (nd) of the sixth lens element 60 is n6. An Abbe number (Vd) of the first lens element 10 is υ1; an Abbe number (Vd) of the second lens element 20 is υ2; an Abbe number (Vd) of the third lens element 30 is υ3; and an Abbe number (Vd) of the fourth lens element 40 is υ4; an Abbe number (Vd) of the fifth lens element 50 is υ5; and an Abbe number (Vd) of the sixth lens element 60 is υ6.

### First Embodiment

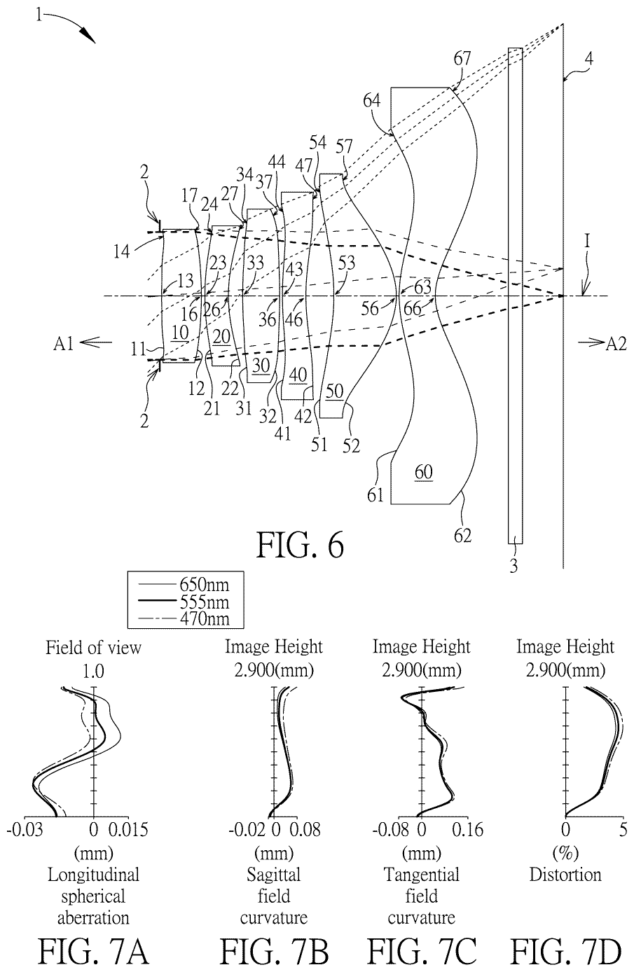

Please refer to FIG. 6 which illustrates the first embodiment of the optical imaging lens 1 of the present invention. Please refer to FIG. 7A for the longitudinal spherical aberration on the image plane 4 of the first embodiment; please refer to FIG. 7B for the field curvature aberration on the sagittal direction; please refer to FIG. 7C for the field curvature aberration on the tangential direction; and please refer to FIG. 7D for the distortion aberration. The Y axis of the spherical aberration in each embodiment is “field of view” for 1.0. The Y axis of the field curvature aberration and the distortion aberration in each embodiment stands for the “image height” (ImgH), and the image height of the first embodiment is 2.900 mm.

The optical imaging lens 1 in the first embodiment is mainly composed of six lens elements which have refracting power, i.e. the first lens element 10, the second lens element 20, the third lens element 30, the fourth lens element 40, the fifth lens element 50 and the sixth lens element 60 plus an aperture stop 2 and an image plane 4. The aperture stop 2 in the first embodiment is provided at a side of the first lens element 10 which faces the object side A1.

The first lens element 10 has positive refracting power. An optical axis region 13 of the object-side surface 11 of the first lens element 10 is convex and a periphery region 14 of the object-side surface 11 of the first lens element 10 is concave. An optical axis region 16 of the image-side surface 12 of the first lens element 10 is convex and a periphery region 17 of the image-side surface 12 of the first lens element 10 is convex. Besides, both the object-side surface 11 and the image-side surface 12 of the first lens element 10 are aspherical surfaces, but it is not limited thereto.

The second lens element 20 has negative refracting power. An optical axis region 23 of the object-side surface 21 of the second lens element 20 is convex and a periphery region 24 of the object-side surface 21 of the second lens element 20 is convex. An optical axis region 26 of the image-side surface 22 of the second lens element 20 is concave and a periphery region 27 of the image-side surface 22 of the second lens element 20 is concave. Besides, both the object-side surface 21 and the image-side surface 22 of the second lens element 20 are aspherical surfaces, but it is not limited thereto.

The third lens element 30 has positive refracting power. An optical axis region 33 of the object-side surface 31 of the third lens element 30 is convex and a periphery region 34 of the object-side surface 31 of the third lens element 30 is convex. An optical axis region 36 of the image-side surface 32 of the third lens element 30 is convex and a periphery region 37 of the image-side surface 32 of the third lens element 30 is convex. Besides, both the object-side surface 31 and the image-side surface 32 of the third lens element 30 are aspherical surfaces, but it is not limited thereto.

The fourth lens element 40 has negative refracting power. An optical axis region 43 of the object-side surface 41 of the fourth lens element 40 is convex and a periphery region 44 of the object-side surface 41 of the fourth lens element 40 is concave. An optical axis region 46 of the image-side surface 42 of the fourth lens element 40 is concave and a periphery region 47 of the image-side surface 42 of the fourth lens element 40 is concave. Besides, both the object-side surface 41 and the image-side surface 42 of the fourth lens element 40 are aspherical surfaces, but it is not limited thereto.

The fifth lens element 50 has positive refracting power. An optical axis region 53 of the object-side surface 51 of the fifth lens element 50 is concave and a periphery region 54 of the object-side surface 51 of the fifth lens element 50 is concave. An optical axis region 56 of the image-side surface 52 of the fifth lens element 50 is convex and a periphery region 57 of the image-side surface 52 of the fifth lens element 50 is convex. Besides, both the object-side surface 51 and the image-side surface 52 of the fifth lens element 50 are aspherical surfaces, but it is not limited thereto.

The sixth lens element 60 has negative refracting power. An optical axis region 63 of the object-side surface 61 of the sixth lens element 60 is convex and a periphery region 64 of the object-side surface 61 of the sixth lens element 60 is concave. An optical axis region 66 of the image-side surface 62 of the sixth lens element 60 is concave and a periphery region 67 of the image-side surface 62 of the sixth lens element 60 is convex. Besides, both the object-side surface 61 and the image-side surface 62 of the sixth lens element 60 are aspherical surfaces, but it is not limited thereto.

In the optical imaging lens element 1 of the present invention, from the first lens element 10 to the sixth lens element 60, all the 12 surfaces, such as the object-side surfaces Nov. 21, 1931/41/51/61 and the image-side surfaces Dec. 22, 1932/42/52/62 are aspherical surfaces, but they are not limited thereto. If a surface is aspherical, these aspheric coefficients are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i}$$

In which:
Y represents a vertical distance from a point on the aspherical surface to the optical axis I;
Z represents the depth of an aspherical surface (the perpendicular distance between the point of the aspherical surface at a distance Y from the optical axis I and the tangent plane of the vertex on the optical axis I of the aspherical surface);
R represents the radius of curvature of the lens element surface close to the optical axis I;
K is a conic constant;
aᵢ is the aspheric coefficient of the i^{th} order, and the a₂ coefficient in each embodiment is 0.

The material parameters of the lens elements disclosed in the optical data of the embodiments use the nd refractive index and Vd Abbe number format of the International Glass Code, so that those of ordinary skill in the art may enable the specific material implementation. Among them, nd refers to the refractive index of the substance at the d yellow helium line 587.56 nanometers (nm), and Vd is calculated based on the refractive index of the substance at the d, F and C wavelengths in the Fraunhofer spectrum.

The focal length values disclosed in the optical data of the embodiments are calculated based on the refractive index of the wavelength band implemented by the optical system. The primary wavelength of the embodiments of the present invention is 555 nm. Therefore, the focal length values of the present invention are based on the materials calculated at a refractive index of 555 nm.

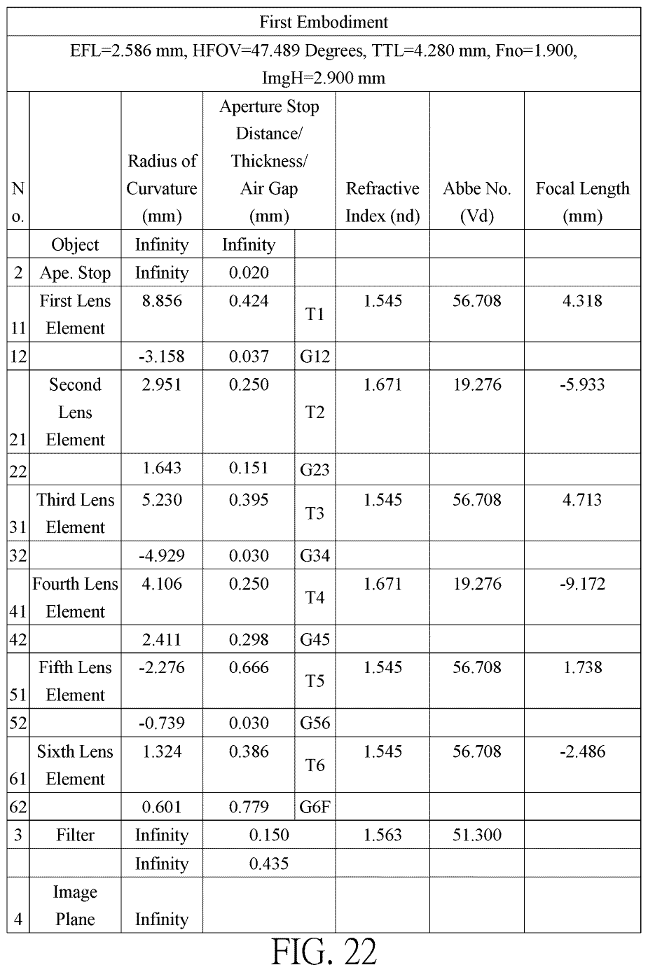

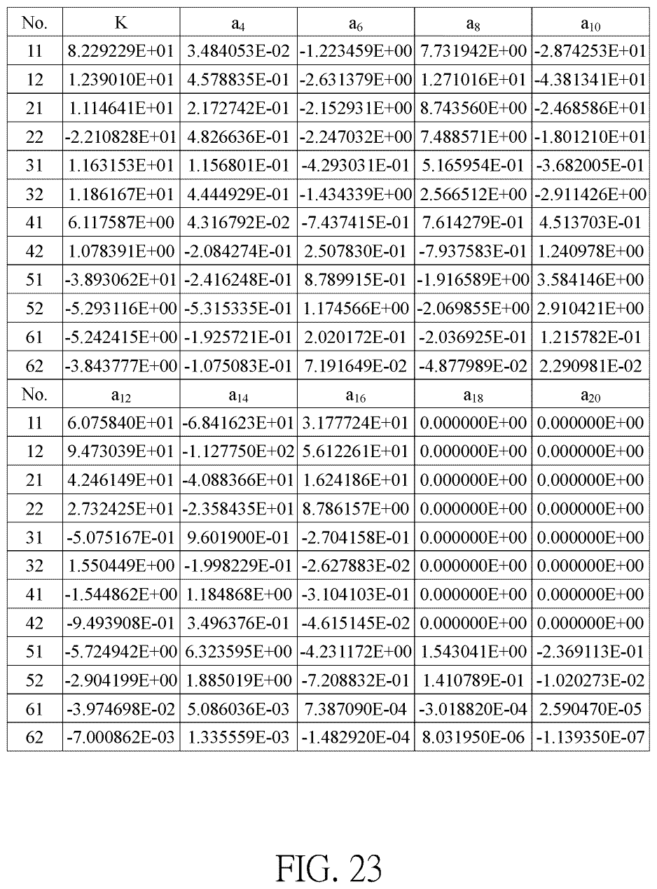

The optical data of the first embodiment of the optical imaging lens 1 are shown in FIG. 22 while the aspheric surface data are shown in FIG. 23. In the present embodiments of the optical imaging lens, the f-number of the entire optical imaging lens is Fno, EFL is the effective focal length, HFOV stands for the half field of view of the entire optical imaging lens, and the unit for the image height (ImgH), the radius of curvature, the thickness and the focal length is in millimeters (mm). In this embodiment, EFL=2.586 mm; HFOV=47.489 degrees; TTL=4.280 mm; Fno=1.900; ImgH=2.900 mm.

### Second Embodiment

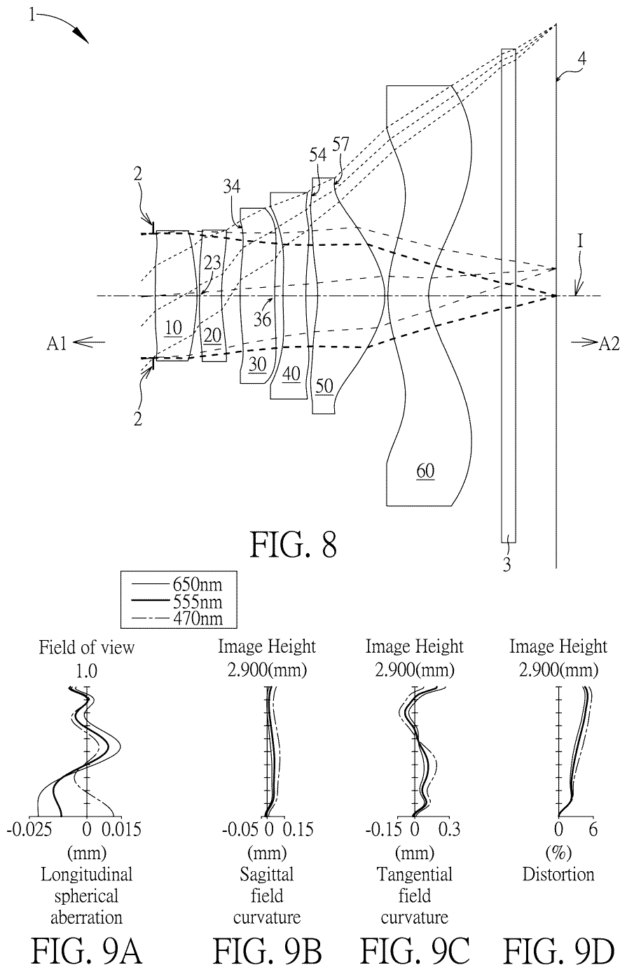

Please refer to FIG. 8 which illustrates the second embodiment of the optical imaging lens 1 of the present invention. It is noted that from the second embodiment to the following embodiments, in order to simplify the figures, only the components different from what the first embodiment has, and the basic lens elements will be labeled in figures. Other components that are the same as what the first embodiment has, such as a convex surface or a concave surface, are omitted in the following embodiments. Please refer to FIG. 9A for the longitudinal spherical aberration on the image plane 4 of the second embodiment, please refer to FIG. 9B for the field curvature aberration on the sagittal direction, please refer to FIG. 9C for the field curvature aberration on the tangential direction, and please refer to FIG. 9D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the optical axis region 23 of the object-side surface 21 of the second lens element 20 is concave, the periphery region 34 of the object-side surface 31 of the third lens element 30 is concave, the optical axis region 36 of the image-side surface 32 of the third lens element 30 is concave, the fourth lens element 40 has positive refracting power, the periphery region 54 of the object-side surface 51 of the fifth lens element 50 is convex, and the periphery region 57 of the image-side surface 52 of the fifth lens element 50 is concave.

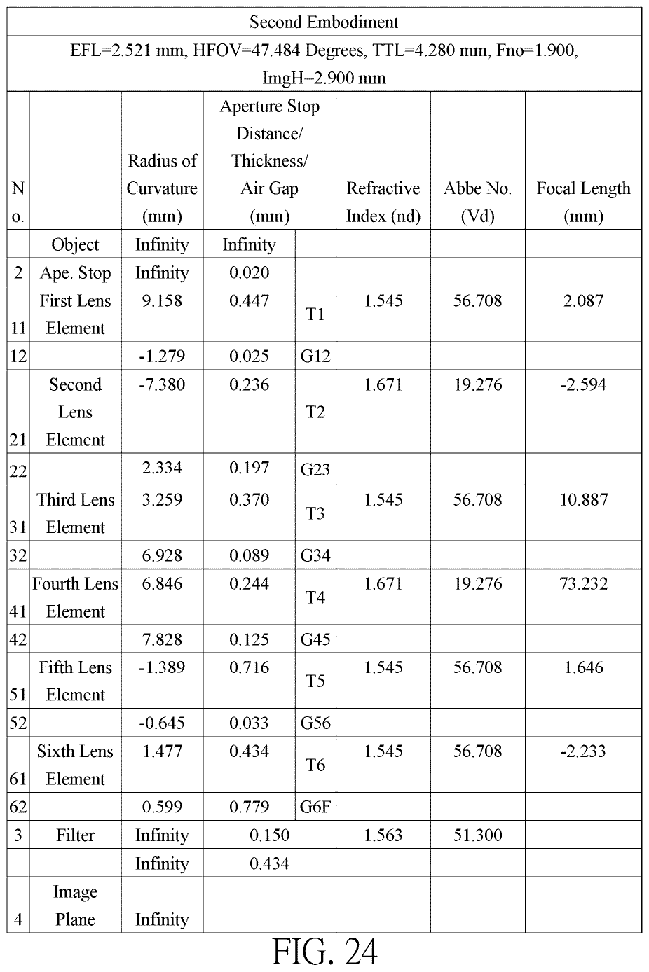

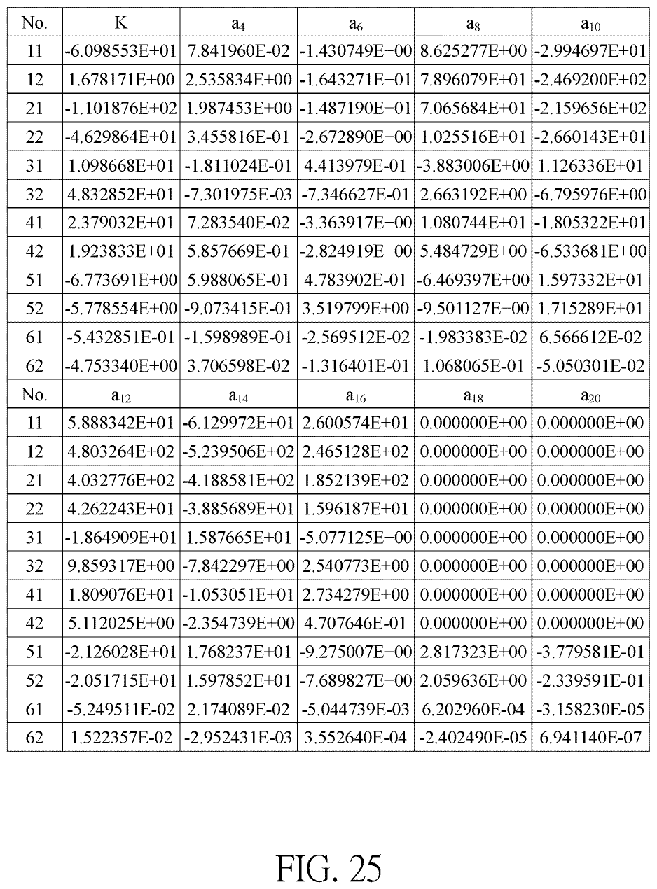

The optical data of the second embodiment of the optical imaging lens are shown in FIG. 24 while the aspheric surface data are shown in FIG. 25. In this embodiment, EFL=2.521 mm; HFOV=47.484 degrees; TTL=4.280 mm; Fno=1.900; ImgH=2.900 mm. In particular, the longitudinal spherical aberration of the optical imaging lens in this embodiment is better than that of the optical imaging lens in the first embodiment.

### Third Embodiment

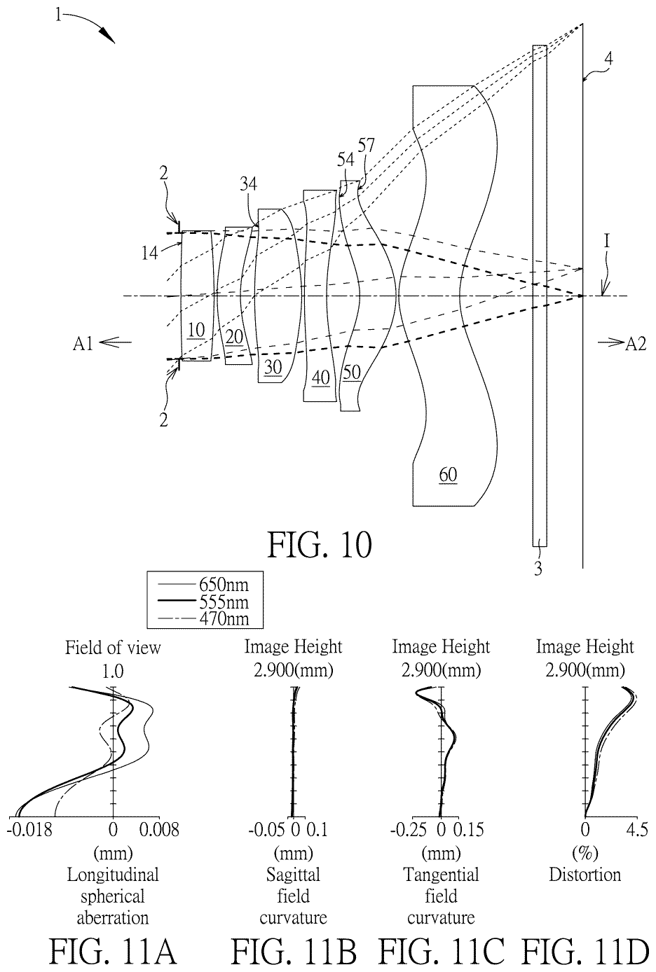

Please refer to FIG. 10 which illustrates the third embodiment of the optical imaging lens 1 of the present invention. Please refer to FIG. 11A for the longitudinal spherical aberration on the image plane 4 of the third embodiment; please refer to FIG. 11B for the field curvature aberration on the sagittal direction; please refer to FIG. 11C for the field curvature aberration on the tangential direction; and please refer to FIG. 11D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 14 of the object-side surface 11 of the first lens element 10 is convex, the periphery region 34 of the object-side surface 31 of the third lens element 30 is concave, the fifth lens element 50 has negative refracting power, the periphery region 54 of the object-side surface 51 of the fifth lens element 50 is convex, the periphery region 57 of the image-side surface 52 of the fifth lens element 50 is concave and the sixth lens element 60 has positive refracting power.

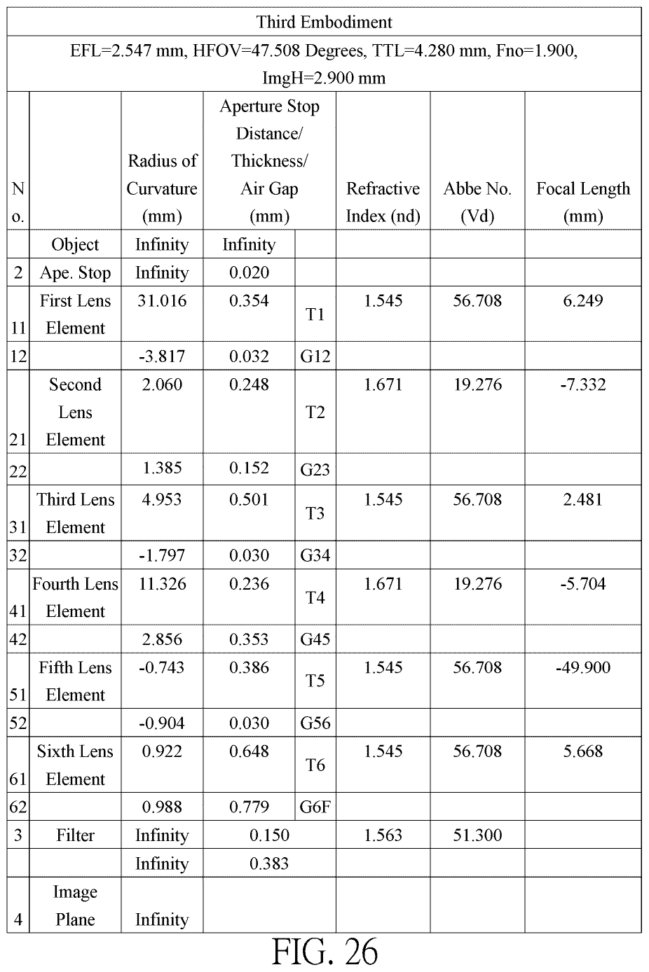

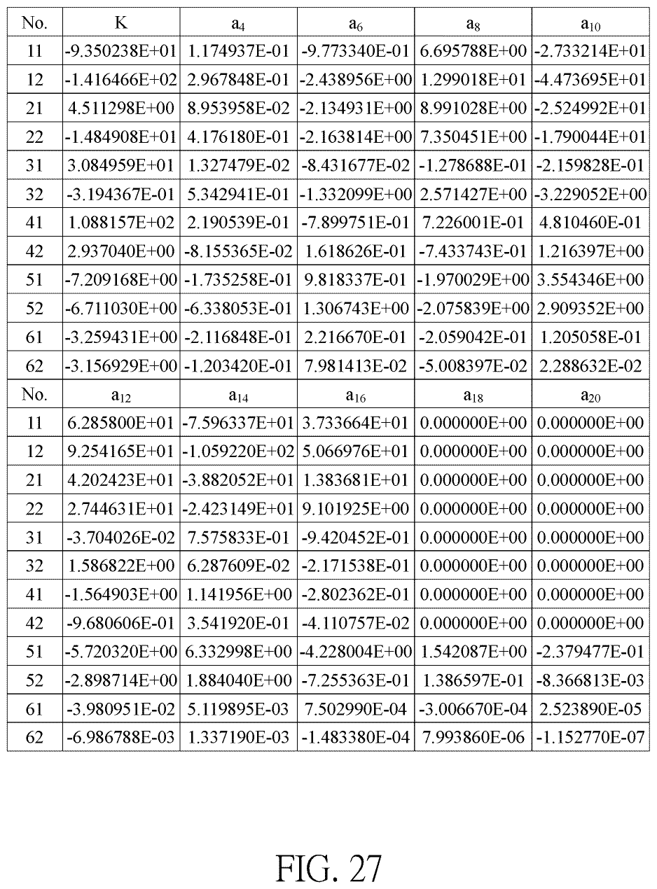

The optical data of the third embodiment of the optical imaging lens are shown in FIG. 26 while the aspheric surface data are shown in FIG. 27. In this embodiment, EFL=2.547 mm; HFOV=47.508 degrees; TTL=4.280 mm; Fno=1.900; ImgH=2.900 mm. In particular, 1) the longitudinal spherical aberration of the optical imaging lens in this embodiment is better than that of the optical imaging lens in the first embodiment, 2) the distortion aberration of the optical imaging lens in this embodiment is better than that of the optical imaging lens in the first embodiment, and 3) the thickness difference between the periphery region and the optical axis region of the optical imaging lens in this embodiment is smaller than that of the optical imaging lens in the first embodiment so it is easier to fabricate the optical imaging lens to have a higher yield.

### Fourth Embodiment

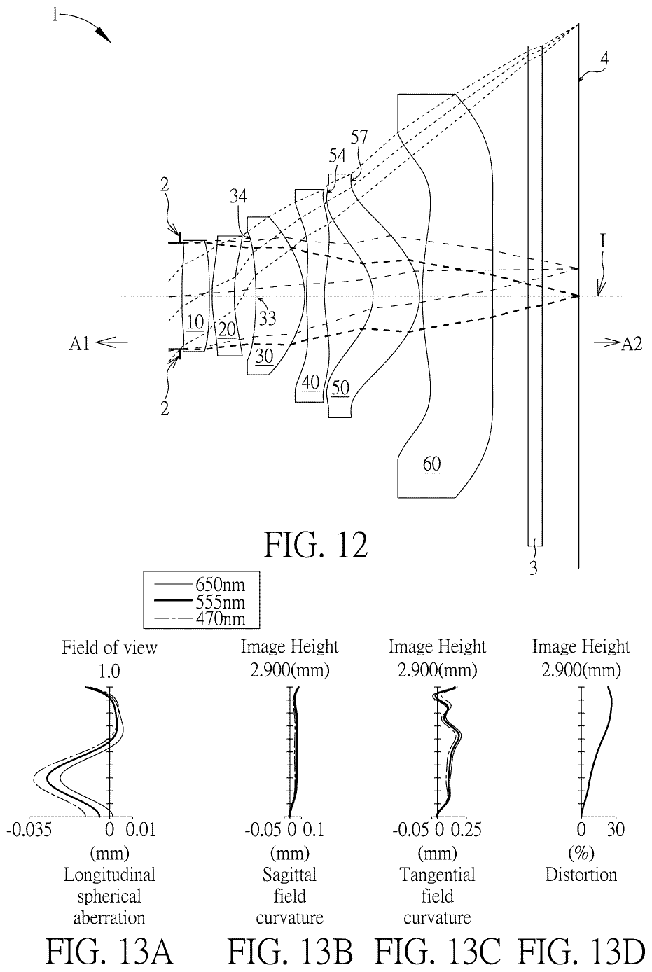

Please refer to FIG. 12 which illustrates the fourth embodiment of the optical imaging lens 1 of the present invention. Please refer to FIG. 13A for the longitudinal spherical aberration on the image plane 4 of the fourth embodiment; please refer to FIG. 13B for the field curvature aberration on the sagittal direction; please refer to FIG. 13C for the field curvature aberration on the tangential direction; and please refer to FIG. 13D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the second lens element 20 has positive refracting power, the optical axis region 33 of the object-side surface 31 of the third lens element 30 is concave, the periphery region 34 of the object-side surface 31 of the third lens element 30 is concave, the periphery region 54 of the object-side surface 51 of the fifth lens element 50 is convex, the periphery region 57 of the image-side surface 52 of the fifth lens element 50 is concave and the sixth lens element 60 has positive refracting power.

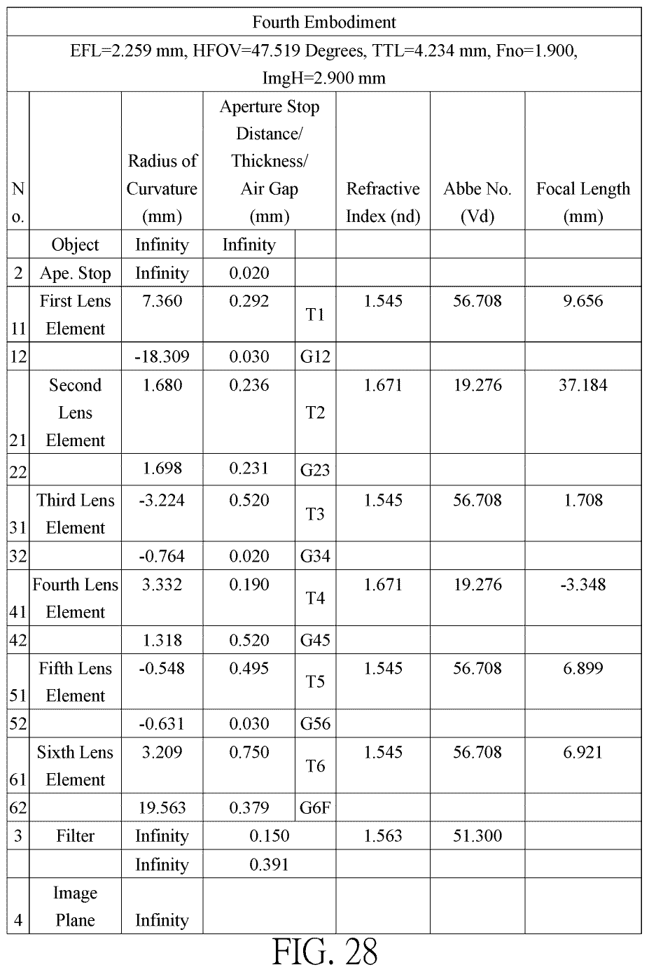

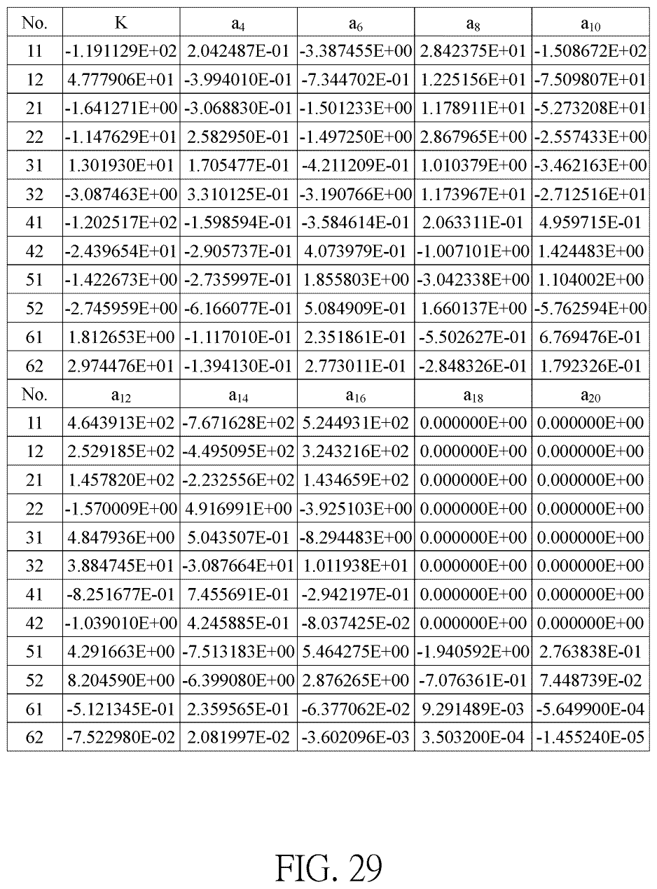

The optical data of the fourth embodiment of the optical imaging lens are shown in FIG. 28 while the aspheric surface data are shown in FIG. 29. In this embodiment, EFL=2.259 mm; HFOV=47.519 degrees; TTL=4.234 mm; Fno=1.900; ImgH=2.900 mm. In particular, the thickness difference between the periphery region and the optical axis region of the optical imaging lens in this embodiment is smaller than that of the optical imaging lens in the first embodiment so it is easier to fabricate the optical imaging lens to have a higher yield.

### Fifth Embodiment

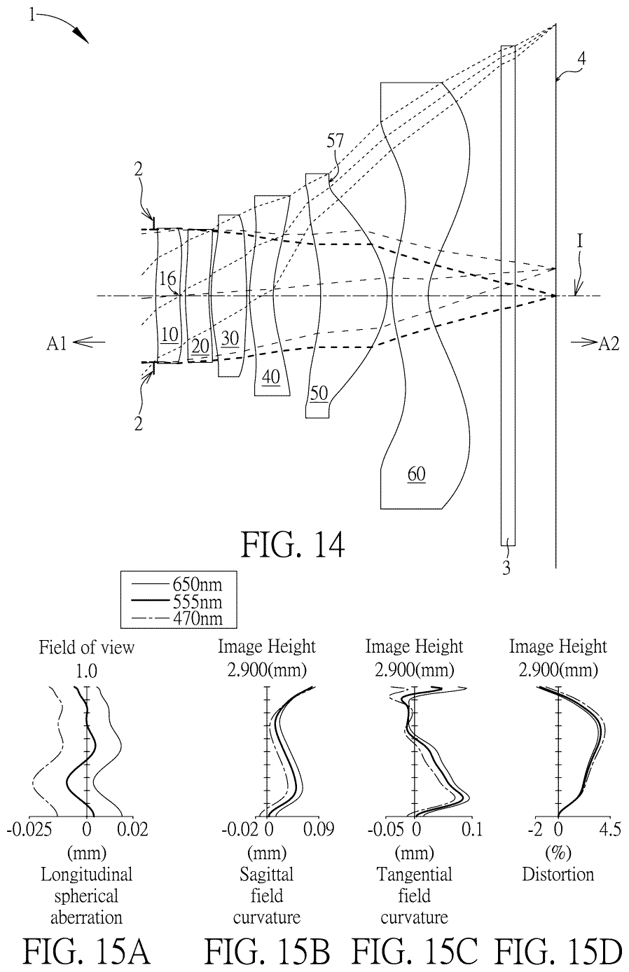

Please refer to FIG. 14 which illustrates the fifth embodiment of the optical imaging lens 1 of the present invention. Please refer to FIG. 15A for the longitudinal spherical aberration on the image plane 4 of the fifth embodiment; please refer to FIG. 15B for the field curvature aberration on the sagittal direction; please refer to FIG. 15C for the field curvature aberration on the tangential direction, and please refer to FIG. 15D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the first lens element 10 has negative refracting power, the optical axis region 16 of the image-side surface 12 of the first lens element 10 is concave and the periphery region 57 of the image-side surface 52 of the fifth lens element 50 is concave.

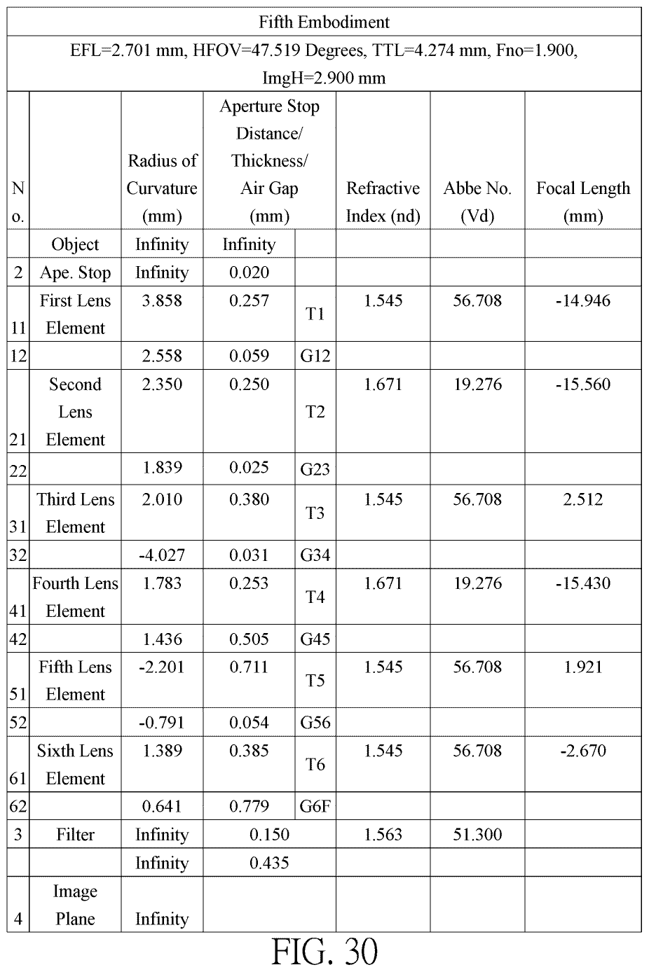

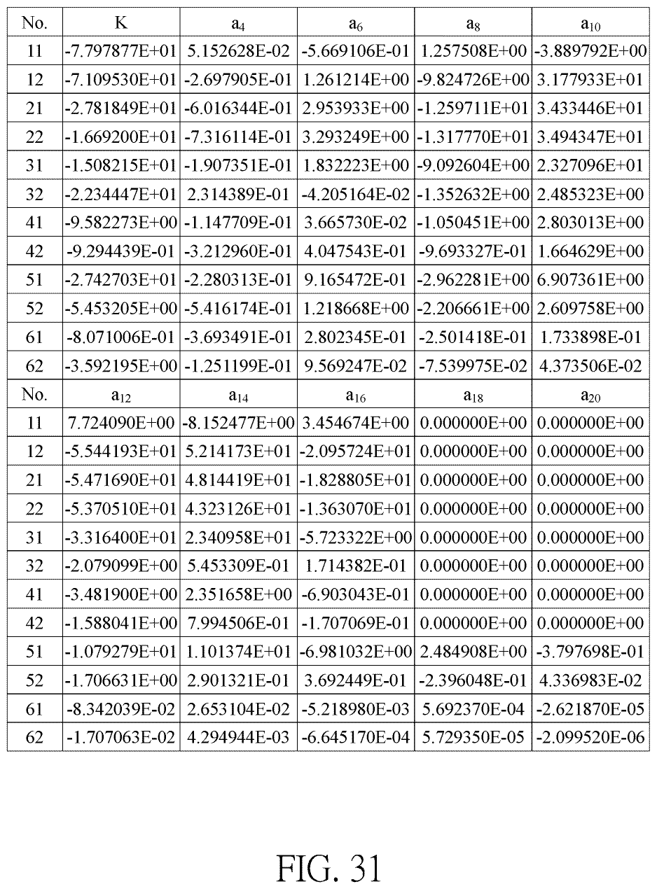

The optical data of the fifth embodiment of the optical imaging lens are shown in FIG. 30 while the aspheric surface data are shown in FIG. 31. In this embodiment, EFL=2.701 mm; HFOV=47.519 degrees; TTL=4.274 mm; Fno=1.900; ImgH=2.900 mm. In particular, the field curvature aberration on the tangential direction of the optical imaging lens in this embodiment is better than that of the optical imaging lens in the first embodiment.

### Sixth Embodiment

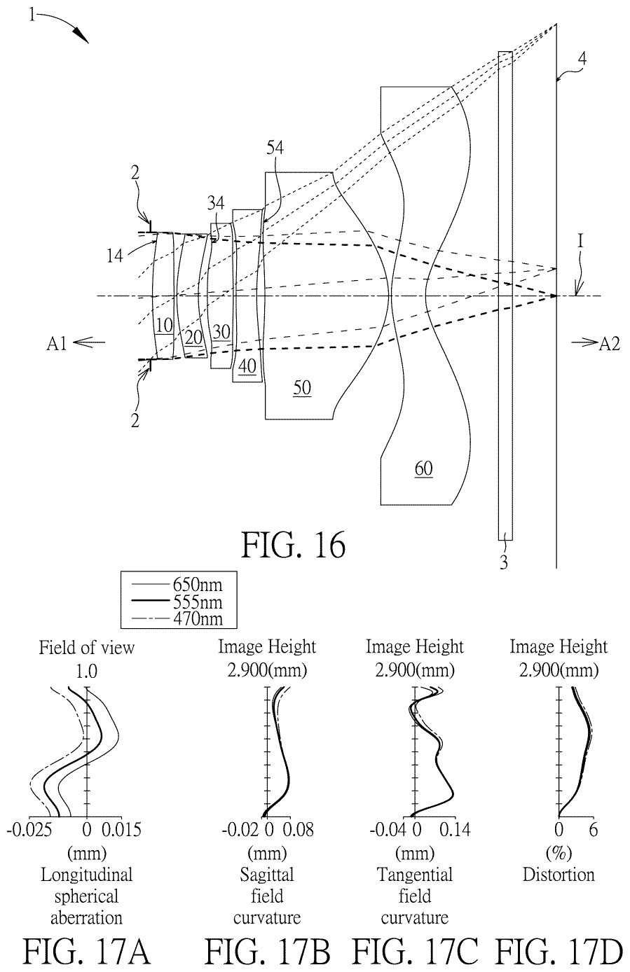

Please refer to FIG. 16 which illustrates the sixth embodiment of the optical imaging lens 1 of the present invention. Please refer to FIG. 17A for the longitudinal spherical aberration on the image plane 4 of the sixth embodiment; please refer to FIG. 17B for the field curvature aberration on the sagittal direction; please refer to FIG. 17C for the field curvature aberration on the tangential direction, and please refer to FIG. 17D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 14 of the object-side surface 11 of the first lens element 10 is convex, the periphery region 34 of the object-side surface 31 of the third lens element 30 is concave, and the periphery region 54 of the object-side surface 51 of the fifth lens element 50 is convex.

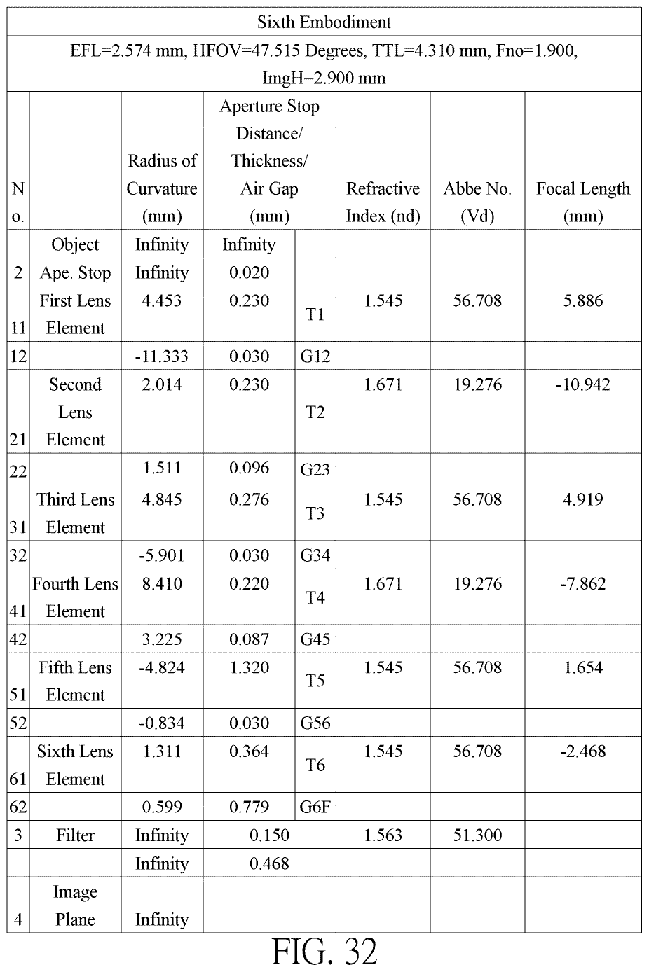

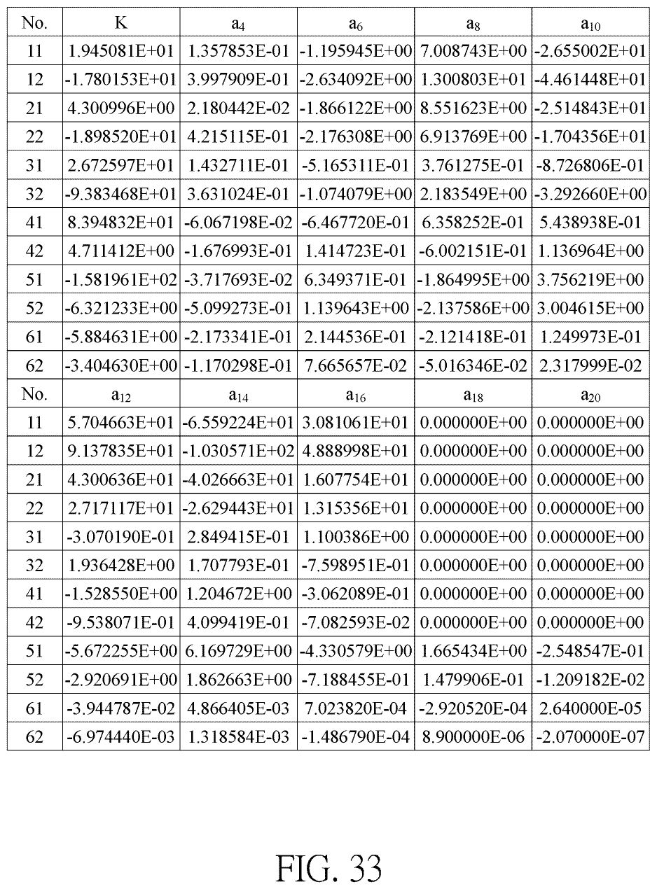

The optical data of the sixth embodiment of the optical imaging lens are shown in FIG. 32 while the aspheric surface data are shown in FIG. 33. In this embodiment, EFL=2.574 mm; HFOV=47.515 degrees; TTL=4.310 mm; Fno=1.900; ImgH=2.900 mm. In particular, 1) the longitudinal spherical aberration of the optical imaging lens in this embodiment is better than that of the optical imaging lens in the first embodiment, 2) the field curvature aberration on the tangential direction of the optical imaging lens in this embodiment is better than that of the optical imaging lens in the first embodiment, and 3) the thickness difference between the periphery region and the optical axis region of the optical imaging lens in this embodiment is smaller than that of the optical imaging lens in the first embodiment so it is easier to fabricate the optical imaging lens to have a higher yield.

### Seventh Embodiment

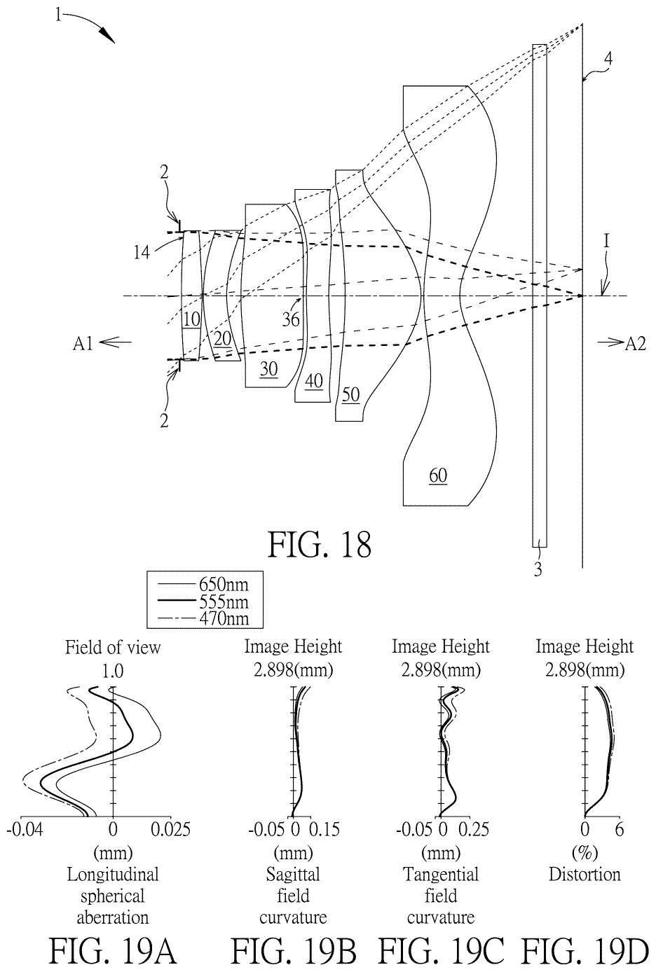

Please refer to FIG. 18 which illustrates the seventh embodiment of the optical imaging lens 1 of the present invention. Please refer to FIG. 19A for the longitudinal spherical aberration on the image plane 4 of the seventh embodiment; please refer to FIG. 19B for the field curvature aberration on the sagittal direction; please refer to FIG. 19C for the field curvature aberration on the tangential direction, and please refer to FIG. 19D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 14 of the object-side surface 11 of the first lens element 10 is convex, and the optical axis region 36 of the image-side surface 32 of the third lens element 30 is concave.

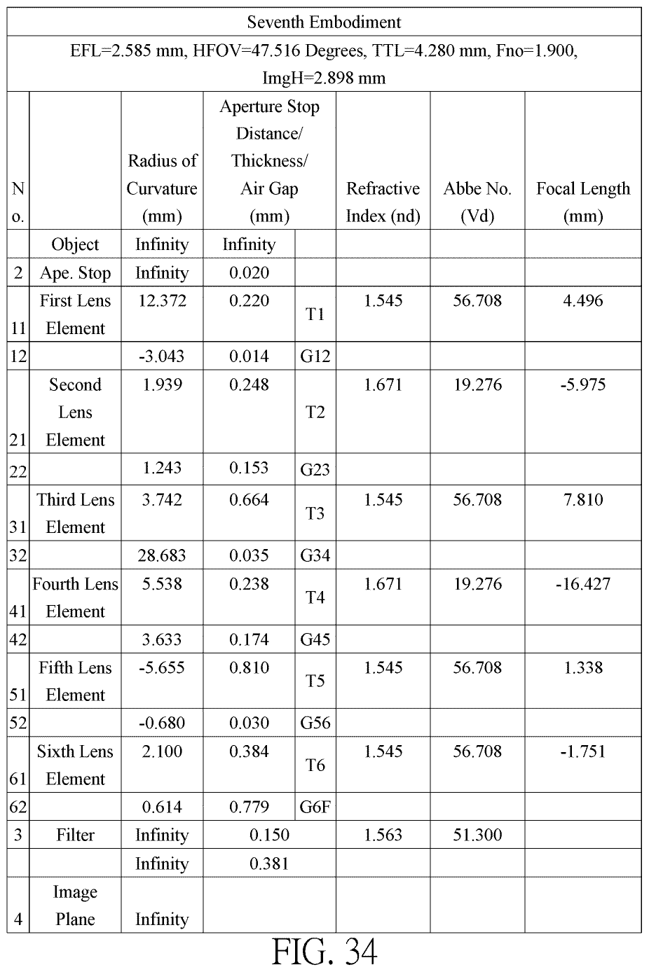

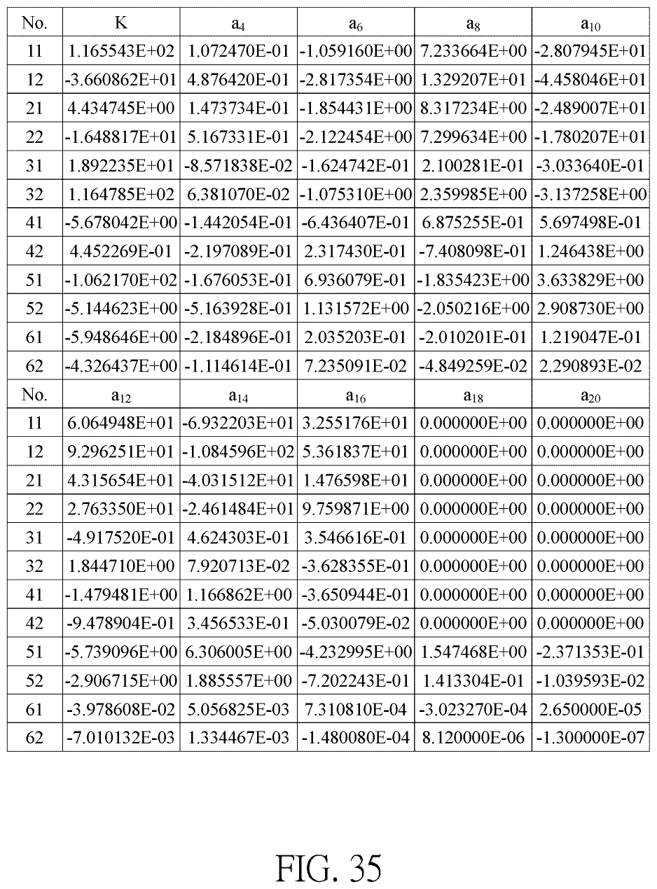

The optical data of the seventh embodiment of the optical imaging lens are shown in FIG. 34 while the aspheric surface data are shown in FIG. 35. In this embodiment, EFL=2.585 mm; HFOV=47.516 degrees; TTL=4.280 mm; Fno=1.900; ImgH=2.898 mm.

### Eighth Embodiment

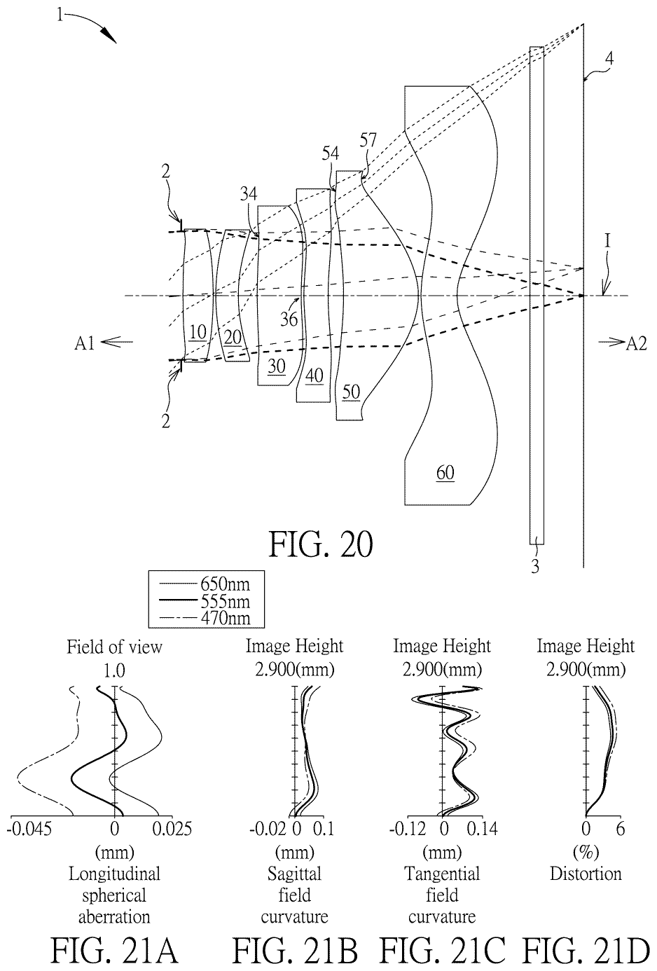

Please refer to FIG. 20 which illustrates the eighth embodiment of the optical imaging lens 1 of the present invention. Please refer to FIG. 21A for the longitudinal spherical aberration on the image plane 4 of the eighth embodiment; please refer to FIG. 21B for the field curvature aberration on the sagittal direction; please refer to FIG. 21C for the field curvature aberration on the tangential direction, and please refer to FIG. 21D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the third lens element 30 has negative refracting power, the periphery region 34 of the object-side surface 31 of the third lens element 30 is concave, the optical axis region 36 of the image-side surface 32 of the third lens element 30 is concave, the fourth lens element 40 has positive refracting power, the periphery region 54 of the object-side surface 51 of the fifth lens element 50 is convex, and the periphery region 57 of the image-side surface 52 of the fifth lens element 50 is concave.

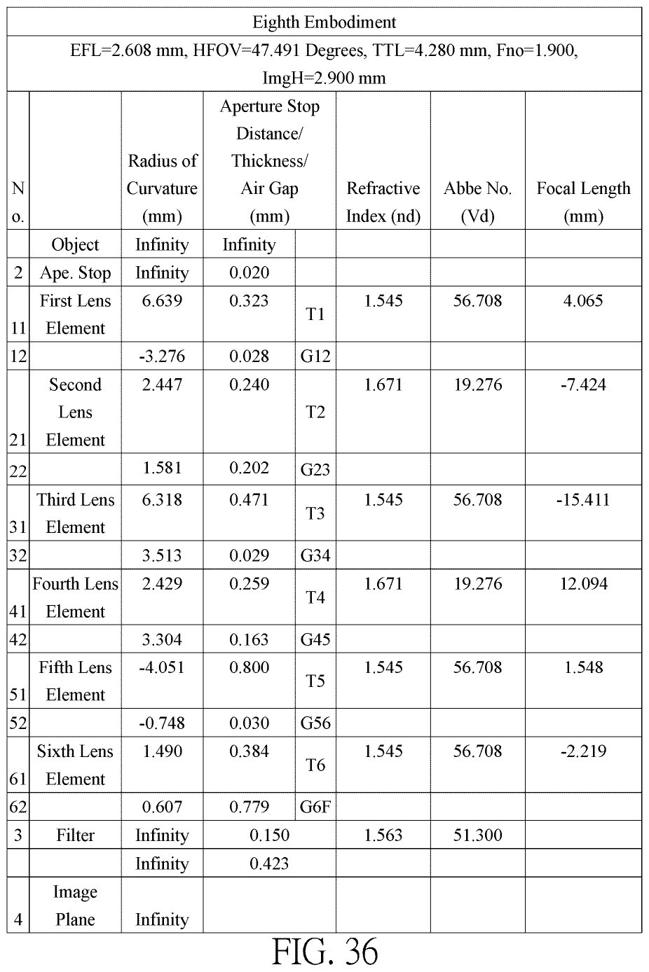

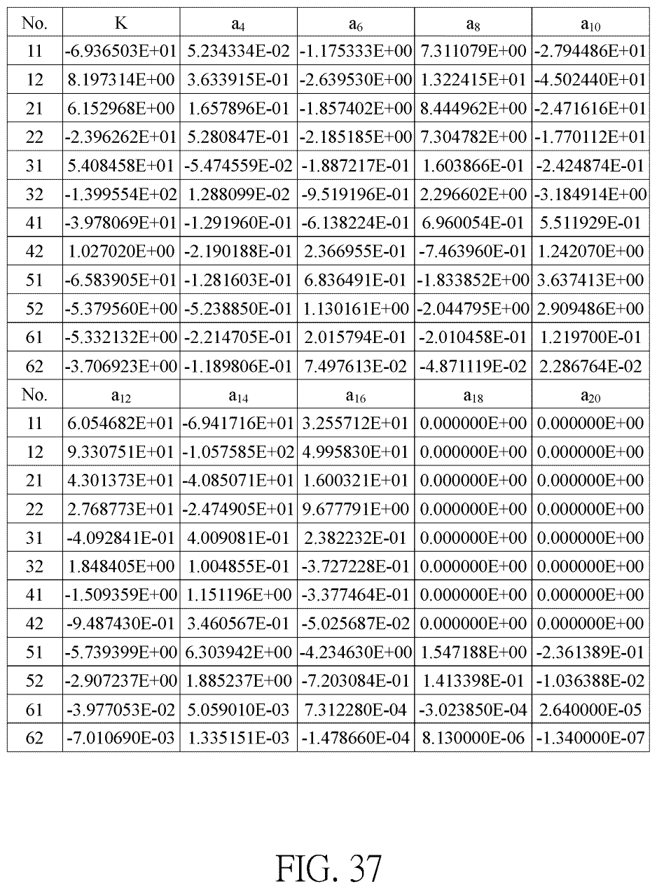

The optical data of the eighth embodiment of the optical imaging lens are shown in FIG. 36 while the aspheric surface data are shown in FIG. 37. In this embodiment, EFL=2.608 mm; HFOV=47.491 degrees; TTL=4.280 mm; Fno=1.900; ImgH=2.900 mm.

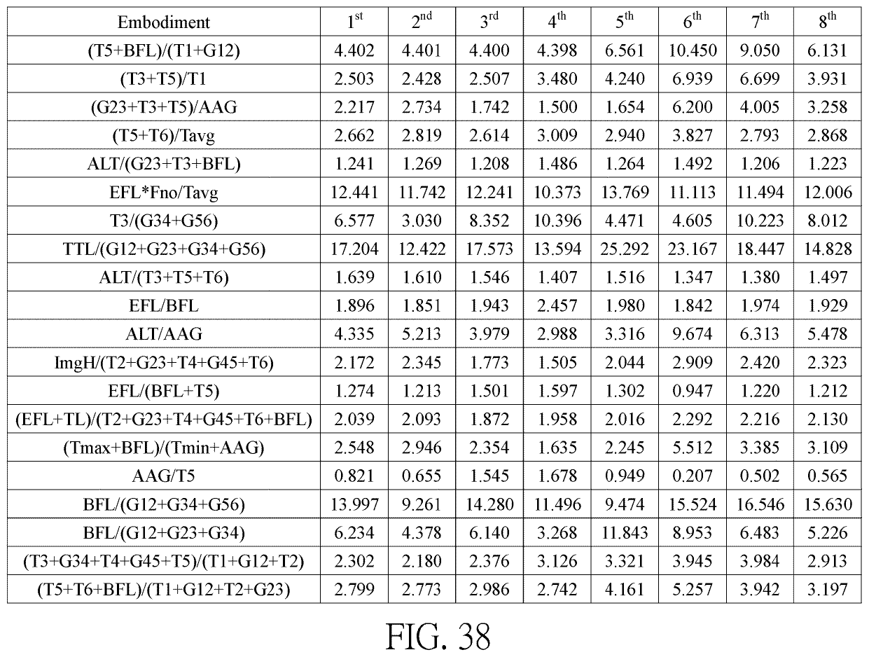

Some important ratios in each embodiment are shown in FIG. 38.

Various embodiments of the present invention provide an optical imaging lens of six lens elements with a small f-number, with a small size, of excellent imaging quality, of good optical performance and which is technically possible. For example, the satisfactions of a design of the following some lens surface shapes, some lens refracting power or some parameters may effectively optimize the imaging quality of the optical imaging lens 1 of the present invention, and achieve the corresponding beneficial efficacy:

1. When the periphery region 17 of the image-side surface 12 of the first lens element 10 is convex to go with that the periphery region 27 of the image-side surface 22 of the second lens element 20 is concave, a periphery region 47 of the image-side surface 42 of the fourth lens element 40 is concave, it is able to improve the aberration of the optical imaging lens on the marginal image plane and to increase the luminous flux. The limitation of the ratio of (T5+BFL)/(T1+G12) 24.390 enables a larger proportion of the thickness T5 of the fifth lens element 50 along the optical axis I and the back focal length BFL than a sum of the front section of the thickness T1 of the first lens element 10 along the optical axis I and the air gap G12 between the first lens element 10 and the second lens element 20 along the optical axis I so that a larger thickness T5 of the fifth lens element 50 achieves an effect of a uniform optical path before the light enters the sixth lens element 60 in the case of controlling the length of the system and reducing the volume. A larger back focal length BFL is to effectively increase the imaging space and make the optical path more parallel and uniform to reduce the influence of the aberration before focusing, thereby improving the clarity and quality of the image. The preferable range of (T5+BFL)/(T1+G12) is 4.390≤(T5+BFL)/(T1+G12)≤11.000.

To further go with the following (1)˜(3), the respective efficacy is as follows:
(1) that the optical axis region 43 of the object-side surface 41 of the fourth lens element 40 is convex, the periphery region 44 of the object-side surface 41 of the fourth lens element 40 is concave and the optical axis region 53 of the object-side surface 51 of the fifth lens element 50 is concave may further enhance the overall focusing effect of the optical imaging lens;
(2) that the periphery region 24 of the object-side surface 21 of the second lens element 20 is convex, the optical axis region 43 of the object-side surface 41 of the fourth lens element 40 is convex, the optical axis region 63 of the object-side surface 61 of the sixth lens element 60 is convex and the optical axis region 66 of the image-side surface 62 of the sixth lens element 60 is concave may further enhance the overall focusing effect of the optical imaging lens as well;
(3) that the periphery region 37 of the image-side surface 32 of the third lens element 30 is convex, the periphery region 44 of the object-side surface 41 of the fourth lens element 40 is concave, the optical axis region 53 of the object-side surface 51 of the fifth lens element 50 is concave and the optical axis region 66 of the image-side surface 62 of the sixth lens element 60 is concave is able to further improve the aberration of the optical imaging lens on the marginal image plane and enhance the overall focusing effect of the optical imaging lens.

2. In order to shorten the system length of the optical imaging lens and to ensure the imaging quality, the air gaps between lens elements may be decreased or the lens thickness may be reduced appropriately, but the difficulty of manufacturing and the imaging quality must be taken into consideration at the same time. Therefore, if the numerical limitations of the following conditional formulae are satisfied, a better arrangement of the embodiments of the present invention may be achieved. When a preferable range is met, the aberration and distortion of the optical imaging lens may be improved, and the spherical aberration may be further improved when a more preferable range is met.
(T3+T5)/T122.400, and the preferable range is 2.400≤(T3+T5)/T137.000;
(G23+T3+T5)/AAG≥1.500, and the preferable range is 1.500≤(G23+T3+T5)/AAG≤6.500;
(T5+T6)/Tavg≥2.600, and the preferable range is 2.600≤(T5+T6)/Tavg≤4.000;
T3/(G34+G56)≥3.000, and the preferable range is 3.000≤T3/(G34+G56)≤11.000;
TTL/(G12+G23+G34+G56)≥12.400, and the preferable range is 12.400≤TTL/(G12+G23+G34+G56)≤27.000;
ALT/(T3+T5+T6)≤1.650, and the preferable range is 1.300≤ALT/(T3+T5+T6)≤1.650;
ALT/AAG>2.900, and the preferable range is 2.900≤ALT/AAG≤10.500; ImgH/(T2+G23+T4+G45+T6)≥1.500, and the preferable range is 1.500≤ImgH/(T2+G23+T4+G45+T6)≤3.100;
(Tmax+BFL)/(Tmin+AAG)≥1.600, and the preferable range is 1.600≤(Tmax+BFL)/(Tmin+AAG)≤6.000;
BFL/(G12+G34+G56)≥9.200, and the preferable range is 9.200≤BFL/(G12+G34+G56)≤19.000;
BFL/(G12+G23+G34)≥3.200, and the preferable range is 3.200≤BFL/(G12+G23+G34)≤12.500;
(T3+G34+T4+G45+T5)/(T1+G12+T2)≥2.100, and the preferable range is 2.100≤(T3+G34+T4+G45+T5)/(T1+G12+T2)≤4.200;
(T5+T6+BFL)/(T1+G12+T2+G23)≥2.700, and the preferable range is 2.700≤(T5+T6+BFL)/(T1+G12+T2+G23)≤5.600;
ALT/(G23+T3+BFL)≤1.500, and the preferable range is 1.100≤ALT/(G23+T3+BFL)≤1.500; AAG/T531.700, and the preferable range is 0.200≤AAG/T5≤1.700.

3. When shortening the length of the lens system, the effective focal length of the system is adjusted by the combination of BFL and thickness of each lens element to ensure the imaging quality at a larger field of view. Therefore, if the numerical limitations of the following conditional formulae are satisfied, a better arrangement of the embodiments of the present invention may be achieved. When a preferable range is met, the aberration and distortion of the optical imaging lens may be improved, and the spherical aberration may be further improved when a more preferable range is met.
EFL*Fno/Tavg≤14.000, and the preferable range is 10.000≤EFL*Fno/Tavg≤14.000;
EFL/BFL≤2.500, the preferable range is 1.750≤EFL/BFL≤2.500;
EFL/(BFL+T5)≤1.600, and the preferable range is 0.900≤EFL/(BFL+T5)≤1.600;
(EFL+TL)/(T2+G23+T4+G45+T6+BFL)≤2.300, and the preferable range is 1.750≤(EFL+TL)/(T2+G23+T4+G45+T6+BFL)≤2.300.

Any arbitrary combination of the parameters of the embodiments may be selected additionally to increase the lens limitations so as to facilitate the design of the same configuration of the present invention.

In the light of the unpredictability of the optical imaging lens, the present invention suggests the above principles to have a reduced system length of the optical imaging lens, a reduced f-number, improved imaging quality or a better fabrication yield to overcome the drawbacks of prior art. Use of plastic materials of the optical imaging lens elements in the embodiments of the present invention may reduce the lens weight and lower the cost.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:

(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.

(2) The comparative relation between the optical parameters is that A is greater than B or A is less than B, for example.

(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens, from an object side to an image side in order along an optical axis comprising: a first lens element, a second lens element, a third lens element, a fourth lens element, a fifth lens element, and a sixth lens element, the first lens element to the sixth lens element each having an object-side surface facing toward the object side and allowing imaging rays to pass through as well as an image-side surface facing toward the image side and allowing the imaging rays to pass through;
a periphery region of the image-side surface of a first lens element is convex;
a periphery region of the image-side surface of the second lens element is concave;
an optical axis region of the object-side surface of the fourth lens element is convex, a periphery region of the object-side surface of the fourth lens element is concave and a periphery region of the image-side surface of the fourth lens element is concave; and
an optical axis region of the object-side surface of the fifth lens element is concave;
wherein lens elements included by the optical imaging lens are only the six lens elements described above, T5 is a thickness of the fifth lens element along the optical axis, BFL is a distance from the image-side surface of the sixth lens element to an image plane along the optical axis, T1 is a thickness of the first lens element along the optical axis, and G12 is a distance of an air gap between the first lens element and the second lens element along the optical axis to satisfy the relationship: (T5+BFL)/(T1+G12)≥4.390.

2. The optical imaging lens of claim 1, wherein T3 is a thickness of the third lens element along the optical axis, and the optical imaging lens satisfies the relationship: (T3+T5)/T122.400.

3. The optical imaging lens of claim 1, wherein G23 is a distance of an air gap between the second lens element and the third lens element along the optical axis, T3 is a thickness of the third lens element along the optical axis and AAG is a sum of a distance of the five air gaps from the first lens element to the sixth lens element along the optical axis, and the optical imaging lens satisfies the relationship: (G23+T3+T5)/AAG≥1.500.

4. The optical imaging lens of claim 1, wherein T6 is a thickness of the sixth lens element along the optical axis and Tavg is an average value of the thickness of the six lens elements from the first lens element to the sixth lens element along the optical axis, and the optical imaging lens satisfies the relationship: (T5+T6)/Tavg≥2.600.

5. The optical imaging lens of claim 1, wherein EFL is an effective focal length of the optical imaging lens, Fno is an f-number of the optical imaging lens and Tavg is an average value of the thickness of the six lens elements from the first lens element to the sixth lens element along the optical axis, and the optical imaging lens satisfies the relationship: EFL*Fno/Tavg≤14.000.

6. The optical imaging lens of claim 1, wherein T3 is a thickness of the third lens element along the optical axis, G34 is a distance of an air gap between the third lens element and the fourth lens element along the optical axis and G56 is an air gap between the fifth lens element and the sixth lens element along the optical axis, and the optical imaging lens satisfies the relationship: T3/(G34+G56)≥3.000.

7. The optical imaging lens of claim 1, wherein TTL is a distance from the object-side surface of the first lens element to the image plane along the optical axis, G23 is a distance of an air gap between the second lens element and the third lens element along the optical axis, G34 is a distance of an air gap between the third lens element and the fourth lens element along the optical axis and G56 is a distance of an air gap between the fifth lens element and the sixth lens element along the optical axis, and the optical imaging lens satisfies the relationship: TTL/(G12+G23+G34+G56)≥12.400.

8. An optical imaging lens, from an object side to an image side in order along an optical axis comprising: a first lens element, a second lens element, a third lens element, a fourth lens element, a fifth lens element, and a sixth lens element, the first lens element to the sixth lens element each having an object-side surface facing toward the object side and allowing imaging rays to pass through as well as an image-side surface facing toward the image side and allowing the imaging rays to pass through;
a periphery region of the image-side surface of a first lens element is convex;
a periphery region of the object-side surface of the second lens element is convex and a periphery region of the image-side surface of the second lens element is concave;
an optical axis region of the object-side surface of the fourth lens element is convex and a periphery region of the image-side surface of the fourth lens element is concave; and
an optical axis region of the object-side surface of the sixth lens element is convex and an optical axis region of the image-side surface of the sixth lens element is concave;
wherein lens elements included by the optical imaging lens are only the six lens elements described above, T5 is a thickness of the fifth lens element along the optical axis, BFL is a distance from the image-side surface of the sixth lens element to an image plane along the optical axis, T1 is a thickness of the first lens element along the optical axis, and G12 is a distance of an air gap between the first lens element and the second lens element along the optical axis to satisfy the relationship: (T5+BFL)/(T1+G12)≥4.390.

9. The optical imaging lens of claim 8, wherein ALT is a sum of thicknesses of all the six lens elements along the optical axis, T3 is a thickness of the third lens element along the optical axis, and T6 is a thickness of the sixth lens element along the optical axis, and the optical imaging lens satisfies the relationship: ALT/(T3+T5+T6)≤1.650.

10. The optical imaging lens of claim 8, wherein EFL is an effective focal length of the optical imaging lens, and the optical imaging lens satisfies the relationship: EFL/BFL≤2.500.

11. The optical imaging lens of claim 8, wherein ALT is a sum of thicknesses of all the six lens elements along the optical axis and AAG is a sum of a distance of the five air gaps from the first lens element to the sixth lens element along the optical axis, and the optical imaging lens satisfies the relationship: ALT/AAG≥2.900.

12. The optical imaging lens of claim 8, wherein ImgH is an image height of the optical imaging lens, T2 is a thickness of the second lens element along the optical axis, G23 is a distance of an air gap between the second lens element and the third lens element along the optical axis, T4 is a thickness of the fourth lens element along the optical axis, G45 is a distance of an air gap between the fourth lens element and the fifth lens element along the optical axis and T6 is a thickness of the sixth lens element along the optical axis, and the optical imaging lens satisfies the relationship: ImgH/(T2+G23+T4+G45+T6)≥1.500.

13. The optical imaging lens of claim 8, wherein G34 is a distance of an air gap between the third lens element and the fourth lens element along the optical axis and G56 is a distance of an air gap between the fifth lens element and the sixth lens element along the optical axis, and the optical imaging lens satisfies the relationship: BFL/(G12+G34+G56)≥9.200.

14. The optical imaging lens of claim 8, wherein EFL is an effective focal length of the optical imaging lens, TL is a distance from the object-side surface of the first lens element to the image-side surface of the sixth lens element along the optical axis, T2 is a thickness of the second lens element along the optical axis, G23 is a distance of an air gap between the second lens element and the third lens element along the optical axis, T4 is a thickness of the fourth lens element along the optical axis, G45 is a distance of an air gap between the fourth lens element and the fifth lens element along the optical axis and T6 is a thickness of the sixth lens element along the optical axis, and the optical imaging lens satisfies the relationship: (EFL+TL)/(T2+G23+T4+G45+T6+BFL)≤2.300.

15. An optical imaging lens, from an object side to an image side in order along an optical axis comprising: a first lens element, a second lens element, a third lens element, a fourth lens element, a fifth lens element, and a sixth lens element, the first lens element to the sixth lens element each having an object-side surface facing toward the object side and allowing imaging rays to pass through as well as an image-side surface facing toward the image side and allowing the imaging rays to pass through;
a periphery region of the image-side surface of a first lens element is convex;
a periphery region of the image-side surface of the second lens element is concave;
a periphery region of the image-side surface of a third lens element is convex;
a periphery region of the object-side surface of the fourth lens element is concave and a periphery region of the image-side surface of the fourth lens element is concave;
an optical axis region of the object-side surface of the fifth lens element is concave; and
an optical axis region of the image-side surface of the sixth lens element is concave;
wherein lens elements included by the optical imaging lens are only the six lens elements described above, T5 is a thickness of the fifth lens element along the optical axis, BFL is a distance from the image-side surface of the sixth lens element to an image plane along the optical axis, T1 is a thickness of the first lens element along the optical axis, and G12 is a distance of an air gap between the first lens element and the second lens element along the optical axis to satisfy the relationship: (T5+BFL)/(T1+G12)≥4.390.

16. The optical imaging lens of claim 15, wherein Tmax is a maximal lens element thickness among the first lens element and the sixth lens element along the optical axis, Tmin is a minimal lens element thickness among the first lens element and the sixth lens element along the optical axis and AAG is a sum of a distance of the five air gaps from the first lens element to the sixth lens element along the optical axis, and the optical imaging lens satisfies the relationship: (Tmax+BFL)/(Tmin+AAG)≥1.600.

17. The optical imaging lens of claim 15, wherein EFL is an effective focal length of the optical imaging lens, and the optical imaging lens satisfies the relationship: EFL/(BFL+T5)≤1.600.

18. The optical imaging lens of claim 15, wherein G23 is a distance of an air gap between the second lens element and the third lens element along the optical axis and G34 is a distance of an air gap between the third lens element and the fourth lens element along the optical axis, and the optical imaging lens satisfies the relationship: BFL/(G12+G23+G34)≥3.200.

19. The optical imaging lens of claim 15, wherein T3 is a thickness of the third lens element along the optical axis, G34 is a distance of an air gap between the third lens element and the fourth lens element along the optical axis, T4 is a thickness of the fourth lens element along the optical axis, G45 is a distance of an air gap between the fourth lens element and the fifth lens element along the optical axis and T2 is a thickness of the second lens element along the optical axis, and the optical imaging lens satisfies the relationship: (T3+G34+T4+G45+T5)/(T1+G12+T2) 22.100.

20. The optical imaging lens of claim 15, wherein T6 is a thickness of the sixth lens element along the optical axis, T2 is a thickness of the second lens element along the optical axis and G23 is a distance of an air gap between the second lens element and the third lens element along the optical axis, and the optical imaging lens satisfies the relationship: (T5+T6+BFL)/(T1+G12+T2+G23)≥2.700.
